(19) United States
(12) Patent Application Publication
(10) Pub. No.: US 2014/0346773 A1
(43) Pub. Date: Nov. 27, 2014

(54) ELASTIC BAND BRACELET MAKING LOOM AND TOOL

(71) Applicant: Steven N. Verona, Miami Beach, FL (US)

(72) Inventor: Steven N. Verona, Miami Beach, FL (US)

(21) Appl. No.: 14/286,079

(22) Filed: May 23, 2014

Related U.S. Application Data
(60) Provisional application No. 61/827,178, filed on May 24, 2013.

(51) Int. Cl. A44C 27/00; B23P 19/00

(52) U.S. Cl. CPC A44C 27/00; B23P 19/00
USPC 289/17; 29/428

(57) ABSTRACT

A loom having pins formed with a base, wherein the pins have a lip that is transverse to the axial shaft of the pin. The base has openings at the juncture of each pin with the base, and each opening is located directly beneath the corresponding lip of the pin when the pins are vertical and extend upward from the base, thereby avoiding the need for any multiple-component mold sections. Mold halves are preferably used to form the loom, the first mold half having fingers that extend into cavities in the second mold half. The lips of each pin are formed between the tip of each finger and the deepest wall of each cavity.

### CROSS-REFERENCES TO RELATED APPLICATIONS

This application claims the benefit of U.S. Provisional Application No. 61/827,178 filed May 24, 2013. This prior application is hereby incorporated by reference.

### STATEMENT REGARDING FEDERALLY-SPONSORED RESEARCH AND DEVELOPMENT

(Not Applicable)

### THE NAMES OF THE PARTIES TO A JOINT RESEARCH AGREEMENT

(Not Applicable)

### REFERENCE TO AN APPENDIX

(Not Applicable)

### BACKGROUND OF THE INVENTION

The invention relates generally to a device for weaving or tying, and more particularly to a device for weaving elastic bands into bracelets and other elongated structures and a method and mold for manufacturing the device.

Looms and hooks are commonly used for weaving with yarn or other string-like materials. Such looms commonly contain a base with a plurality of pins extending upwardly from the base, and the user manually guides the yarn around the pins to form woven textiles. It is also known to use needles to guide the string through and around the pins.

Other looms are used to weave looped structures, such as elastic (e.g., rubber) bands, and some of these looms are manufactured and sold under the trademarks RAINBOW LOOM and TWISTZ BANDZ. These looms are discussed in published U.S. applications numbered 2012/0112457 and 2013/0020802, which are herein incorporated by reference. These looms include a base and a plurality of pin bars. Each pin bar is an integral structure with its pins defined in a single row. A user of these looms selectively assembles the plurality of pin bars to the base to achieve his/her desired pin configuration and create various linked articles. These looms use an elongated tool with a hook on the end thereof to manipulate the elastic bands on and off pins of any pin bars mounted to the base of the loom. Manufacturers must use a complex, multipiece assembly for manufacturing these looms.

Conventional looms for use with elastic bands are complex and expensive, thereby making the cost to the end user too high, and introducing complex structures (such as slide-in molds or multipiece assemblies) to a simple task. The need exists for a loom that is manufactured at low cost while still retaining the durability needed for a quality product, thereby allowing consumers to enjoy use of the loom.

### BRIEF SUMMARY OF THE INVENTION

The invention, including a loom and a hook that are both preferably made of plastic, composite, metal or any other suitable material, is designed for use with looped materials such as rubber and other elastic bands. The loom includes a substantially planar base with multiple rows of spaced pins that extend substantially perpendicularly from the base. The loom is manufactured to form respective cutouts in the base at points where the respective pins are formed with the major plane of the base and to form terminal ends of respective pins substantially parallel to such respective cutouts. The loom designed and manufactured with the base cutouts and corresponding terminal ends of the pins removes the need to form loom components separately, for example the conventional bases and pin bars described in documents incorporated by reference herein, using complex, multipiece assemblies. The formation of these cutouts and corresponding terminal ends of pins also removes the need for conventional manufacturing processes using complex molds with moving components. The base provides a hand-grippable structure for holding the loom in the user's hands. Curves formed on the base allow for convenient hand gripping.

A mold is used to form the loom, and includes a plurality of fingers that extend into a plurality of corresponding cavities. The pins of the loom are formed in the cavities and a tip of each finger is spaced from the deepest wall of the cavity, thereby causing the deepest wall to define the terminal end of each pin and corresponding cutout in the base where each pin is formed with the major plane of the base.

### BRIEF DESCRIPTION OF THE SEVERAL VIEWS OF THE DRAWINGS

FIG. 1 is a view in perspective illustrating a preferred embodiment of the present invention.

FIG. 2 is a top view illustrating the embodiment of FIG. 1.

FIG. 3 is a view in perspective illustrating the embodiment of FIG. 1 from the rear.

FIG. 4 is a bottom view illustrating the embodiment of FIG. 1.

FIG. 5 is a view in perspective illustrating the embodiment of FIG. 1 magnified from the front.

FIG. 6 is a view in perspective illustrating the embodiment of FIG. 1 magnified from the rear.

FIG. 7 is a side view illustrating a portion of the embodiment of FIG. 1.

FIG. 8 is an end view illustrating the embodiment of FIG. 1.

FIG. 9 is an end view illustrating the embodiment of FIG. 1.

FIG. 10 is a top view illustrating a pair of looms adjacent one another in position to be attached to one another.

FIG. 11 is a view in perspective illustrating a mold half used to form the embodiment of FIG. 1.

FIG. 12 is a view in perspective illustrating a second, opposing mold half used to form the embodiment of FIG. 1.

FIG. 13 is a view in perspective illustrating a mold section magnified from FIG. 11.

FIG. 14 is a view in perspective illustrating a mold section magnified from FIG. 12.

FIG. 15 is a schematic section view illustrating the mold sections of FIGS. 13 and 14 in a closed position and simulating a section through a loom at the lines 15-15 of FIG. 2.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Provisional Application No. 61/827,178 filed May 24, 2013 is incorporated in this application by reference.

The loom 10 is shown in the drawings including a substantially planar base 20 with multiple rows of spaced pins 30 that extend substantially perpendicularly from the base 20. The loom 10 is preferably made of plastic (polymer) material, such as polyester or polycarbonate, but can alternatively be manufactured from metal, fiber-reinforced polymer or any other suitable material. The number and size of the pins 30 are not critical, nor is the spacing between pins. Furthermore, larger or smaller looms are contemplated with more or fewer pins than are shown and described herein as examples.

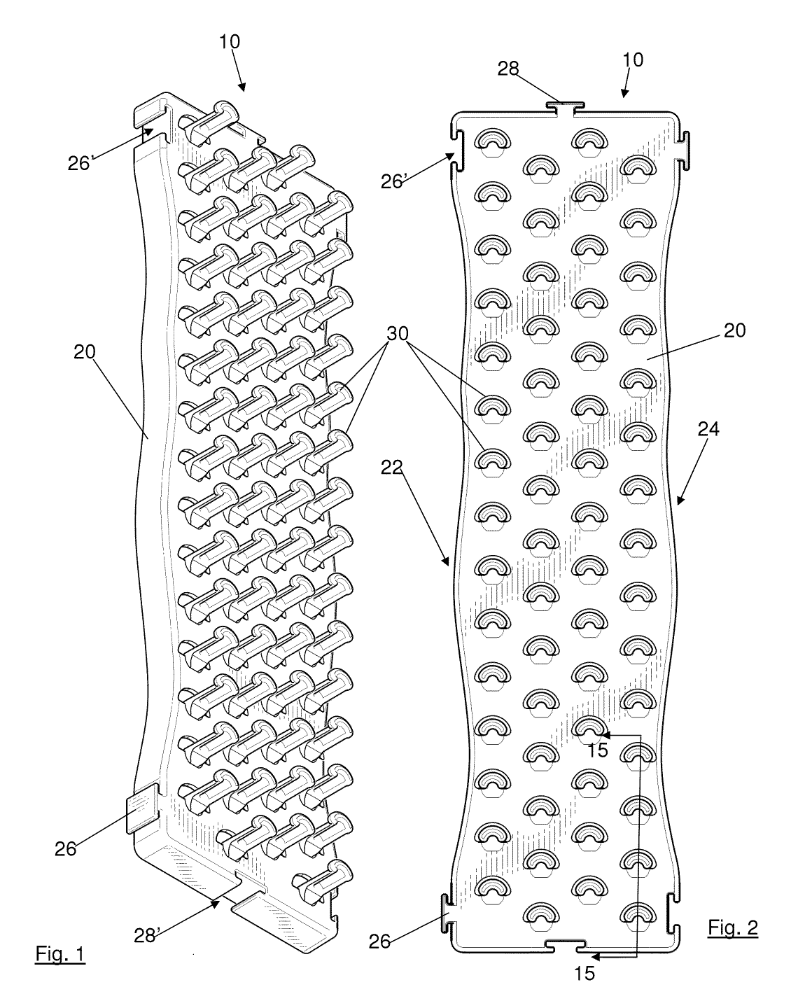

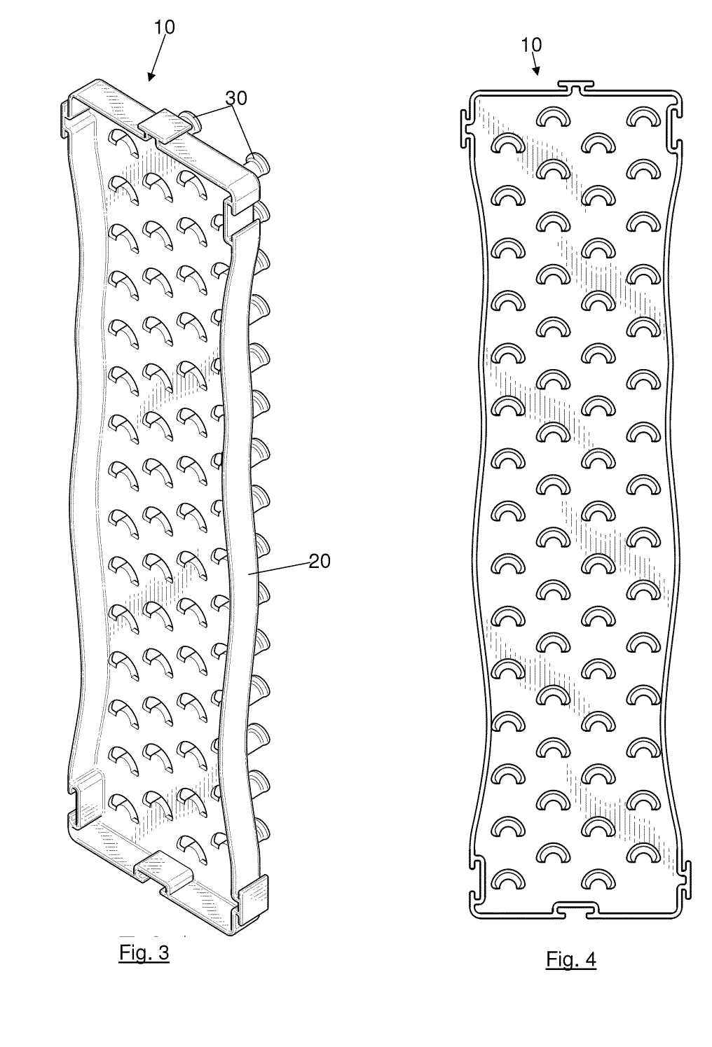

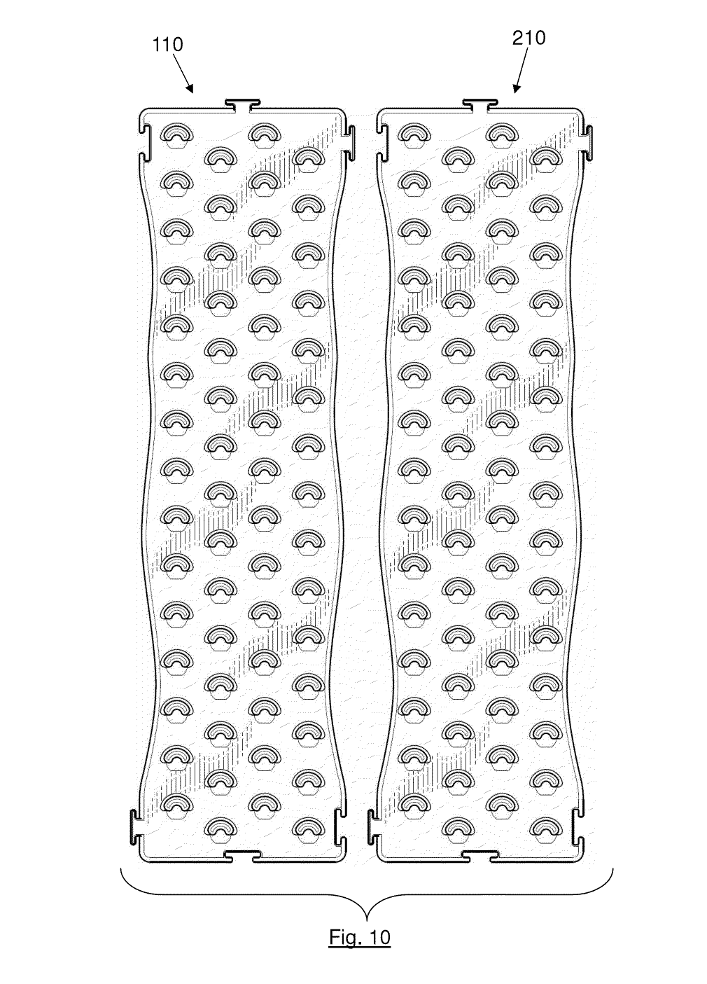

The base 20 is preferably a sheet about one-eighth inch thick with a major panel, and sidewalls 22 and 24 and similar endwalls extending substantially perpendicularly to the major panel. As shown in FIGS. 1-9, the base 20 provides a physical structure with which the pins 30 are integrally formed during manufacturing and a hand-grippable structure for holding the loom 10 in the user's hands. The base 20 has curved sidewalls 22 and 24, which are best viewed in FIGS. 2 and 4, that allow for gripping of the loom 10 by providing an ergonomic fit in the human hand. Typically, the base 20 is held between the thumb and fingers of a hand. The curved walls 22 and 24 shown in the illustrations are formed on the long sides of the base 20, and fit naturally in the hand of the user.

The loom 10 has a locking mechanism for attaching multiple similar looms together in a side-by-side and end-to-end relationship. For example, as shown in FIGS. 1-6 and 8-9, the locking mechanism of loom 10 is formed as one or more protruding dovetails 26 on one side (preferably a long side), and a complementary number of dovetail-shaped voids 26′ on the opposite side to receive the dovetails of an adjacent, similar loom. Dovetails 28 and voids 28′ can also be formed on the short sides. Of course, any type of fastener can be used on the sides of the looms to permit connection of one loom to another, or of one loom to multiple other looms.

It will become apparent that the curves on the long side of one loom matingly receive the curves on the opposite side of an adjacent loom, thereby allowing the dovetails to be inserted into the voids. Furthermore, the curves on abutting sides of adjacent looms do not interfere with one another during the attachment of one loom to the other, as shown in FIG. 10. This attachment can be accomplished by placing the first loom 110 on a flat surface, and then disposing a second loom 210 just above the first with the dovetails of the second loom just above the complementary voids of the first loom. Then the second loom is pressed downwardly to dispose the dovetails of the second loom in the voids of the first loom. This configuration maintains the looms adjacent one another with the second loom's 210 pins aligned with the pins of the first loom 110.

The spacing of the pins 30 and the rows of pins 30 of each of the looms 110 and 210 is the same. Furthermore, when the looms 110 and 210 are attached to each other, the pins of the leftward most side of the second loom 210 are spaced from the pins of the rightward most side of the first loom 110 at a distance substantially equal to the spacing between pins of the first loom 110 and between pins of the second loom 210; attaching the looms together aligns pins in each row of both looms. Thus, attaching two or more looms together allows one to effectively add rows of pins of one or more looms at equal distances from the other loom's pins to permit a greater variety of creations using the combination.

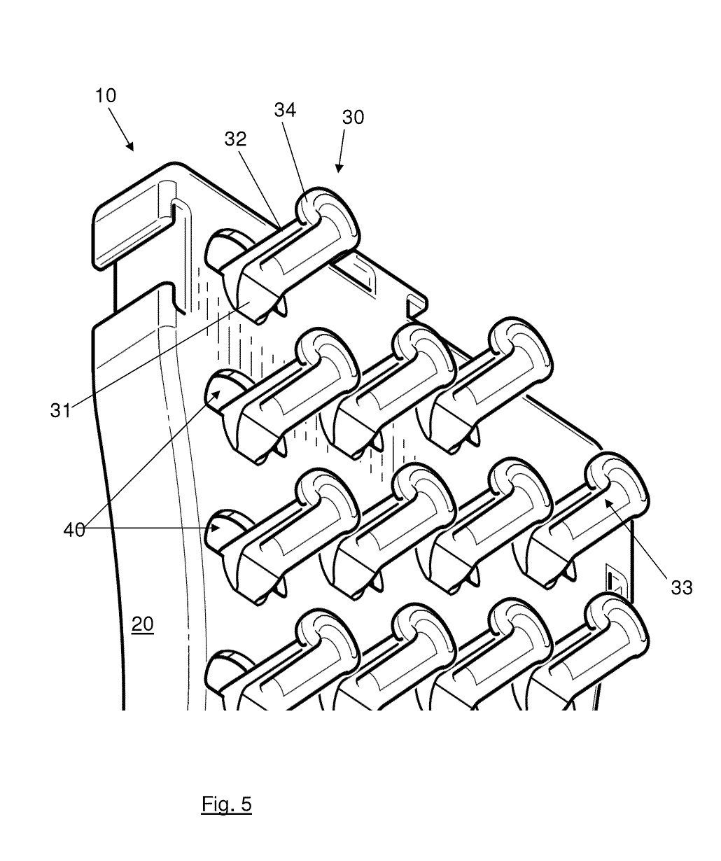

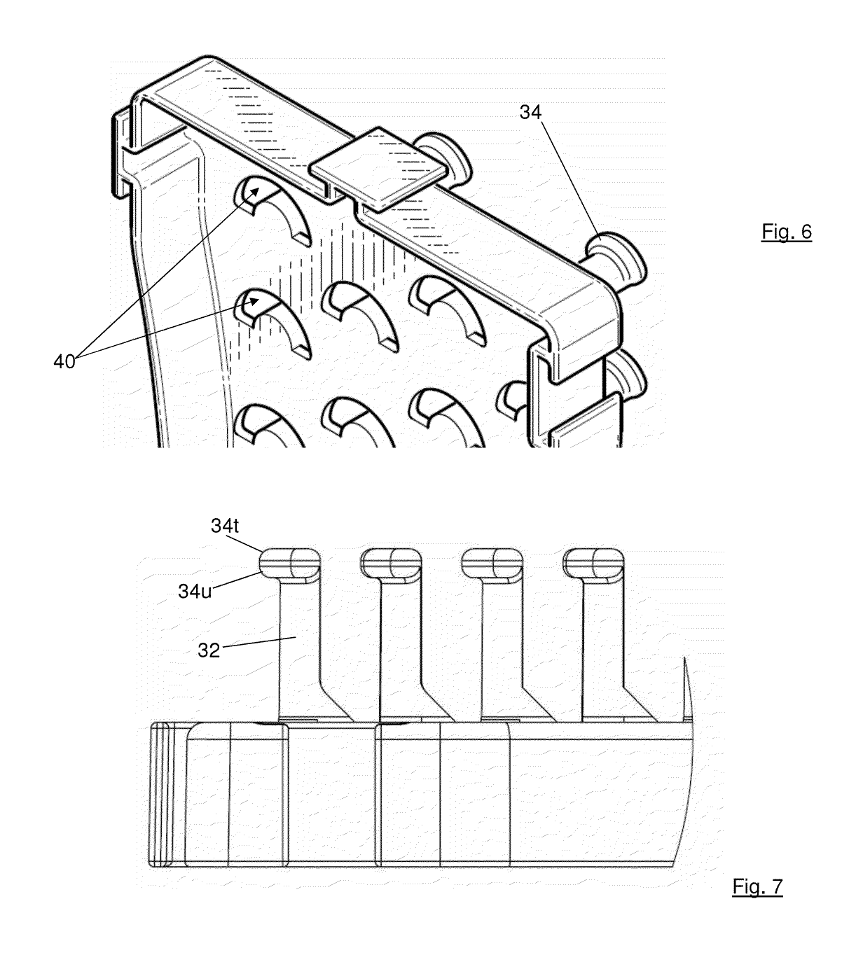

Referring to FIGS. 5-6, each of the pins 30 has a reinforcement taper 31 at the base of its shaft 32 that increases the strength of the point where the shaft 32 is integrally formed with the base 20 during manufacturing. Furthermore, referring to FIGS. 5 and 8, each of the pins' 30 shafts 32 is substantially U-shaped in cross section. The notch 33 formed during manufacturing of the loom 10 by the “valley” of each pin 30 allows a hook tool to grab an elastic band more easily, and even guides a hook tool toward the center as the tip of the tool slides along the length of the pin 30. The U-shaped cross section of each of the pins 30 extends around fewer than 180 degrees; that is, the pins' shafts 32 are formed in a U-shape during manufacturing of the loom 10 as if one cut a circular cylindrical tube lengthwise and removed more than one-half of the circular portion, leaving less than one-half of the circular portion behind. This structural feature leaves significant space in which to fit the hook tool tip so a user can grab only the desired material with the hook. At the same time, this structure keeps a minimal surface area so that when an elastic band is placed against the shaft 32, low friction is maintained, thereby reducing twisting of the bands during placing of the bands on the shafts 32 and removal from the shafts 32. Still further, this structural feature decreases the size of the cutout 40 (described below) formed in the base during manufacturing to increase strength.

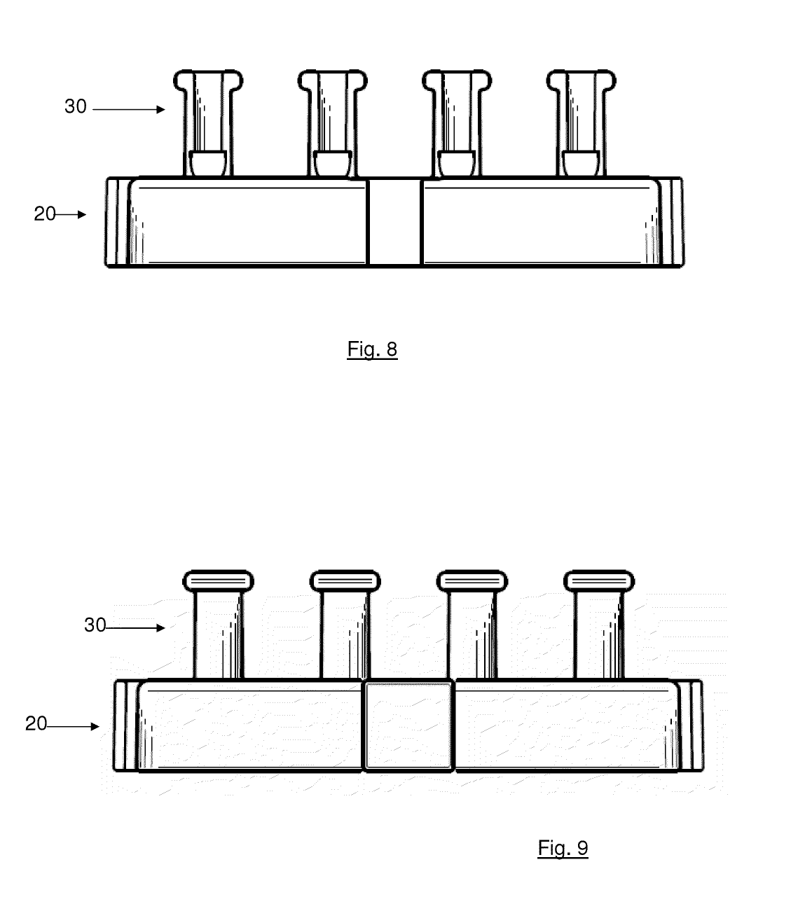

Referring to FIGS. 5-9, each of the pins 30 terminates in a lip 34 that extends substantially perpendicularly from the longitudinal axis of the shaft 32 (and substantially parallel to the major panel of the base 20). Each lip 34 has a radius, as best shown in FIG. 7, for easy loading of the weaving material. The radius underside 34u and radius top side 34t improve weaving by eliminating sharp edges which can cut the weaving material or the user. The radius top side 34t and underside 34u allow the weaving material to more easily be placed on and removed from the pin 30. Additionally, the radiuses reduce twisting of the weaving material because the weaving material can slide over the radius rather than catching on a sharp edge that enhances rolling (which results in twisting) of the material.

Referring to FIGS. 1-8, the spacing of the pins 30 relative to one another is not a critical distance, but is such that it allows ease of use with average-sized fingers for loading and unloading weaving material. The spacing of the pins 30 is selected prior to manufacturing of loom 10 to be far enough from one another that they permit the weaving materials, which can be rubber or other elastic bands, to be placed around, and removed from, the shafts 32 during the subsequent weaving process. Furthermore, the lips 34 retain weaving material on the pins 30 by presenting an obstacle that each elongated band has to roll or slide over to be removed from the respective pin 30. Because the lips 34 require the already elongated elastic band to further elongate to be removed from the pin 30, some force is required to move the band over the lip 34. Placement and removal of the bands is described in the prior art, and the documents incorporated by reference herein, and therefore is not described in detail herein.

There are cutouts 40 formed in the material forming the base 20, as shown in FIGS. 1-6. The cutouts 40 are semi-circular openings formed in the major surface of the base 20 where the pins 30 are integrally formed with the base during manufacturing of the loom 10. The cutouts 40 are formed during manufacturing of the loom 10, and are a result of the means by which the pins 30 generally, and the lips 34 specifically, are integrally formed with the base without using a multi-piece, moving component mold. Formation of the loom 10 will now be described with reference to the Figures.

Referring to FIGS. 1-7, it will be understood that halves of a mold with corresponding features can be disposed in a facing or opposing relationship and pressed together during a single manufacturing process to integrally form base 20 with rows of pins 30 having shafts 32, with U-shaped cross-sections, extending perpendicularly from the major plane of base 20. It will further be understood from these Figures that the corresponding, opposing features of the mold halves form respective cutouts 40 at points where the shaft 32 of respective pins 30 is integrally formed with the major plane of base 20, and form lips 34 at an opposite end of shaft 32 of respective pins 30 and substantially parallel to such respective cutouts 40, without the need for a complex, multi-piece assembly or a mold with moving components.

The loom 10 designed and manufactured with the base cutouts 40 and corresponding lips 34 of the pins 30 removes the need to form loom components separately, for example the conventional bases and pin bars described in documents incorporated by reference herein, using complex, multipiece assemblies. The formation of these cutouts 40 at points where the shaft 32 of each pin 30 is integrally formed with the major plane of base 20 with increased strength, and formation of these lips 34 at the opposite end of each shaft 32 of each pin 30 and substantially parallel to these cutouts 40, also removes the need for conventional manufacturing processes using complex molds with moving components.

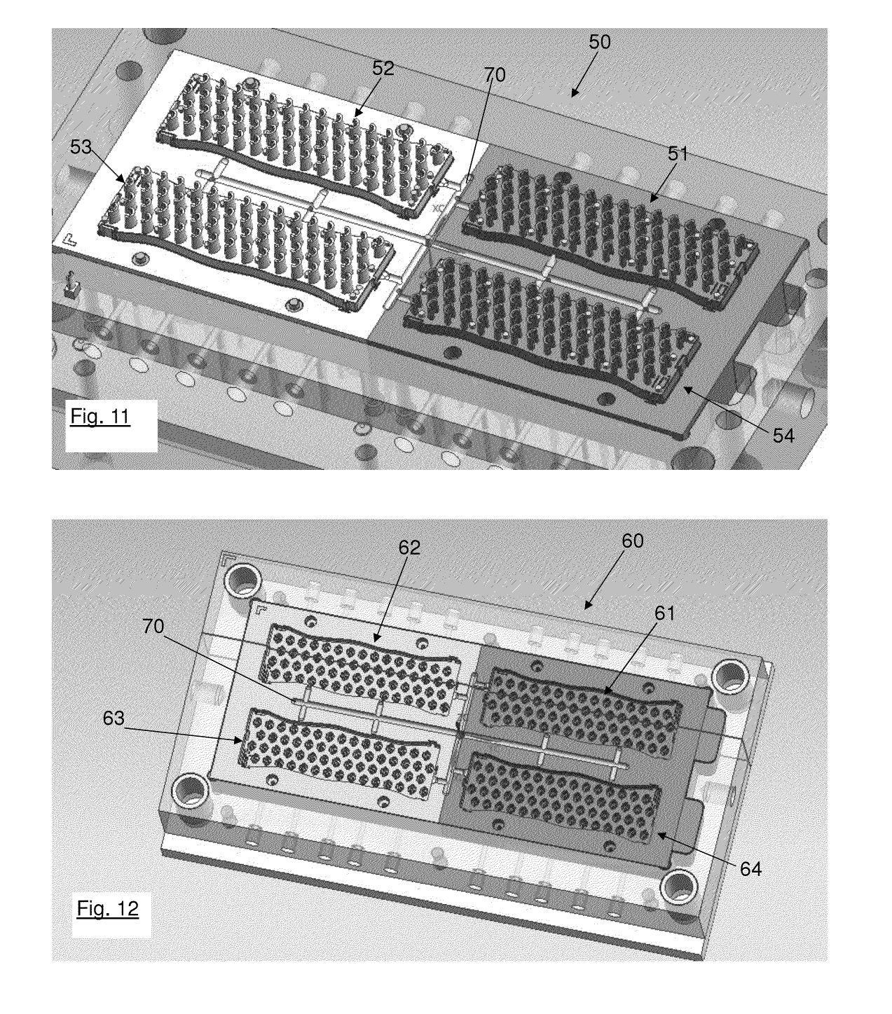

For example, mold halves 50 and 60 are shown in FIGS. 11 and 12. The mold half 50 is shown with four substantially identical sections 51, 52, 53 and 54. The mold half 60 is shown with four substantially identical sections 61, 62, 63 and 64. During use, the mold half 50 is disposed in a facing relationship with the mold half 60, and the two mold halves are moved together until a seal is formed at contacting surfaces, leaving voids and conventional gate cavities 70 therein that allow fluent material to be injected into the cavities 70 and then flow to the voids. As will become apparent from the illustrations of FIGS. 11 and 12, the voids formed between the mold halves 50 and 60 are shaped like the exterior of the loom 10 and gate cavities 70 that form passages.

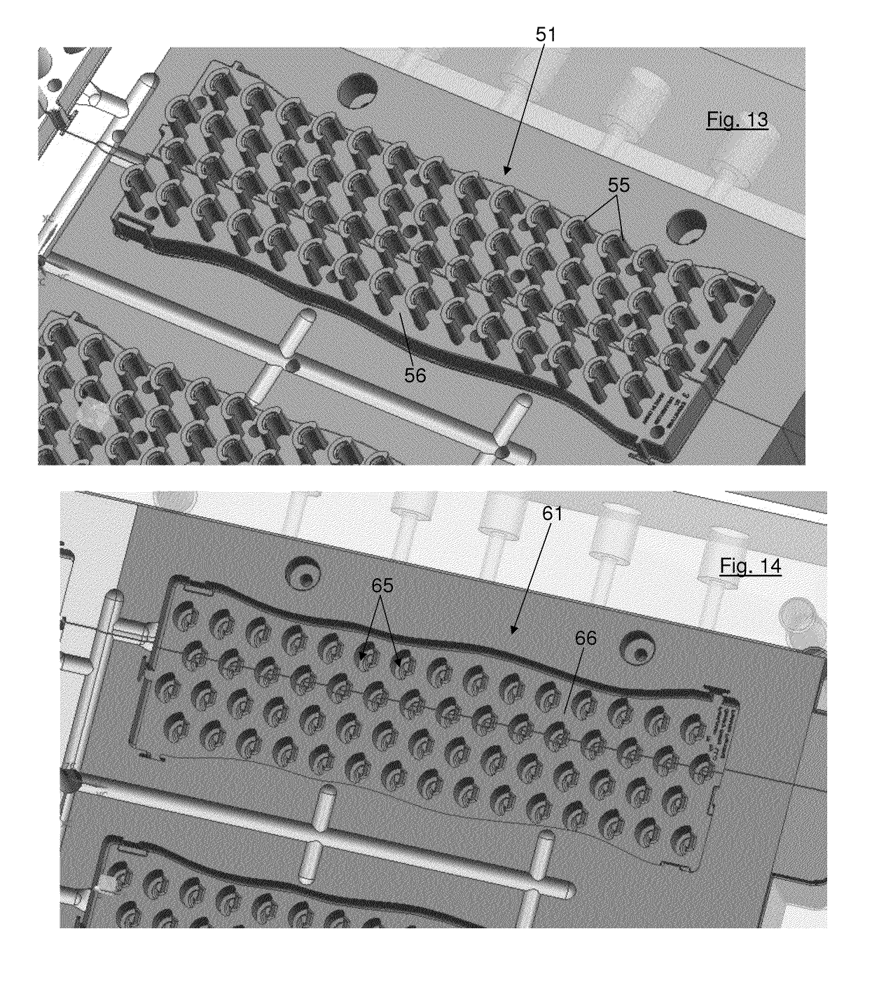

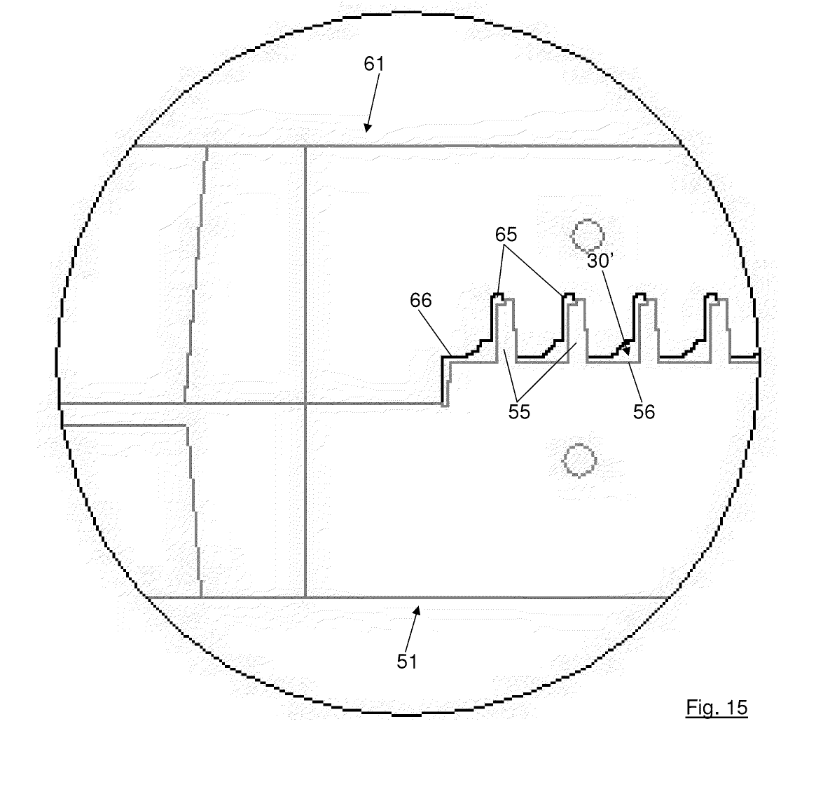

The mold sections 51 and 61 are substantially identical to the corresponding mold sections 52-54 and 62-64, and are described in more detail below as examples of all similar mold sections. Although not all mold sections are described, a person of ordinary skill will understand how the mold halves 50 and 60 operate from the description of the examples of the mold sections 51 and 61. The mold section 51, shown in FIG. 13, has a plurality of fingers 55 with U-shaped cross sections extending substantially perpendicularly from a floor 56. The mold section 61, shown in FIG. 14, has a plurality of corresponding cavities 65 with U-shaped cross sections formed therein, and formed into a ceiling 66. Each finger 55 extends into a corresponding one of the cavities 65 when the mold sections 51 and 61 are in a facing and sealed orientation during manufacturing of loom 10, which is hereafter referred to as when the mold is “closed”.

When the mold is closed, which is illustrated from the side in the magnified cross-section of FIG. 15, each of the fingers 55 extends into a corresponding one of the cavities 65, and the floor 56 is spaced from the ceiling 66 a distance equal to the thickness of the major area of the base 20. In this configuration, a void 30′ is formed between each finger 55 and each cavity 65 that is the shape of each pin 30. That is, when filled with fluent material and hardened, each void 30′ defines the exterior shape of each pin 30 as pins 30 are formed with base 20. It is preferred that when the mold is closed, the material that will form the loom 10 is injected in a fluent form, such as a liquid or semi-liquid, into the voids 30′ of the closed mold. The mold halves 50 and 60 are later separated to expose the hardened material that formed each loom 10. It will become apparent that the illustration of FIG. 15 shows the interior of the closed mold at one end, such as along the line 15-15 of FIG. 2 when the loom 10 is formed in a closed mold.

When the mold is closed, the thin gap formed between the floor 56 and the ceiling 66 defines the major panel of the base 20. Where each finger 55 extends into a corresponding cavity 65, each cutout 40 is formed around a corresponding finger 55 along the plane of material that fills in the thin gap between the floor 56 and the ceiling 66 to form the major panel of base 20. Thus, each cutout 40 is formed by a finger 55 occupying space through the thin planar void that forms the major panel of the base 20.

The tip of the finger 55 is spaced from the deepest wall of the cavity 65, which deepest wall defines the terminal end of each pin 30 during manufacturing. A void is formed in each cavity at the tip of each finger 55, and each void forms a lip 34 extending from each pin's 30 tip. The convex shape of the radius top of each lip 34t is defined by the deepest wall of each cavity 65, and the radius underside of each lip 34u is defined by the tip of a corresponding finger 55. The convex, curved portion of each pin's shaft 32, between the lip 34 and the cutout 40, is defined by one side of the finger 55. The concave U-shaped portion 33 of each pin's shaft 32 is defined by the side of the cavity 65 opposite the finger 55. When the mold sections 51 and 61 are moved apart after the fluent material has hardened sufficiently, the fingers 55 pull away from each pin 30 as each loom 10 is withdrawn by its base from the mold halves 50 and 60. Even though the lips 34 are substantially perpendicular to the direction the mold halves 50 and 60 move apart, no moving mold subcomponents are necessary.

The hook tool is a hand-grippable, elongated wand that is used to assist the user in manipulating the weaving material during the weaving process. A hook is formed at one end that permits the user to hook around the weaving material as is known in the industry. At the opposite end is an ergonomically formed region that is readily grasped by a user.

The hook of the invention has unique design elements as well. The depth of the hook is designed to hold multiple layers of material (i.e. multiple bands). This prevents weaving material from slipping off prematurely during use.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An improved loom having a base and a plurality of pins arranged in rows and extending from the base, the improvement comprising:
(a) each of said plurality of pins is formed with the base adjacent a corresponding opening through the base;
(b) each of said plurality of pins has a lip extending transversely therefrom and substantially parallel to said corresponding opening through the base.

2. The improved loom in accordance with claim 1, wherein each of said plurality of pins has a first side, and wherein a first end of the first side defines a portion of the corresponding opening through the base, and wherein the opposite end of the first side abuts the lip.

3. The improved loom in accordance with claim 2, wherein each of the plurality of pins has a tapered support structure at a junction between the respective pin and the base, on an opposite side of the respective pin from the corresponding opening through the base.

4. The improved loom in accordance with claim 1, wherein lateral walls of the base are curved.

5. The improved loom in accordance with claim 4, wherein lateral walls of the base have means for attaching to a base of another loom.

6. The improved loom in accordance with claim 4, wherein lateral walls of the base have fasteners for attaching to a base of another loom.

7. The improved loom in accordance with claim 6, further comprising a second loom attached to the improved loom, the second loom having a base and a plurality of pins arranged in rows and extending from the base, wherein each of said plurality of pins is formed with the base adjacent a corresponding opening through the base and wherein each of said plurality of pins has a lip extending transversely therefrom and substantially parallel to said corresponding opening through the base.

8. A method of forming a loom, comprising:
(a) forming a first surface of a base along a first plane;
(b) forming a plurality of openings through the first surface;
(c) forming a plurality of pins with the first surface of the base, each one of the plurality of pins extending from the base in a direction substantially perpendicular to the first plane, the step of forming the plurality of pins comprising:
(c)(1) forming a first end of a shaft of each one of the plurality of pins with the first surface of the base and adjacent a respective one of the plurality of openings; and
(c)(2) forming a lip at a second end of the shaft of each one of the plurality of pins opposite the first end, said lip extending transversely therefrom in a direction substantially parallel to the first plane, said lip being substantially aligned with the respective one of the plurality of openings along an axis substantially perpendicular to the first plane; and
(d) forming a plurality of other surfaces of the base along a second plane wherein the second plane is substantially perpendicular to the first plane.

9. The method in accordance with claim 8, wherein the step of forming the first end of the shaft of each one of the plurality of pins further comprises forming the first end to define an edge of the respective one of the plurality of openings.

10. The method in accordance with claim 8, further comprising:
forming a tapered support structure with the shaft of each one of the plurality of pins and the first surface of the base and at a side of the shaft opposite the respective one of the plurality of openings.

11. The method in accordance with claim 8, wherein the plurality of other surfaces of the base are curved.

12. The method in accordance with claim 8, further comprising:
forming a locking mechanism with one or more of the the plurality of other surfaces of the base.

13. The method in accordance with claim 8, further comprising:
(a) forming a first surface of another base along the first plane;
(b) forming a plurality of openings through the first surface of said another base;
(c) forming a plurality of pins with the first surface of said another base, each one of the plurality of pins extending from said another base in a direction substantially perpendicular to the first plane, the step of forming the plurality of pins comprising:
(c)(1) forming a first end of a shaft of each one of the plurality of pins with the first surface of said another base and adjacent a respective one of the plurality of openings through the first surface of said another base; and
(c)(2) forming a lip at a second end of the shaft of each one of the plurality of pins opposite the first end, said lip extending transversely therefrom in a direction substantially parallel to the first plane, said lip being substantially aligned with the respective one of the plurality of openings through the first surface of said another base along an axis substantially perpendicular to the first plane;
(d) forming a plurality of other surfaces of said another base base along the second plane; and
(e) attaching the base to said another base.
